(19) United States
(12) Patent Application Publication
(10) Pub. No.: US 2005/0286529 A1
(43) Pub. Date: Dec. 29, 2005

(54) Method and apparatus for ATM adaptation layer staggered constant bit rate cell scheduling

(76) Inventors: Ambalavanar Arulambalam, Macungie, PA (US); Kenneth Isley, Fogelsville, PA (US); Mark B. Simkins, Lower Macungie Township, PA (US); Seung Yeop Yang, Allentown, PA (US)

Correspondence Address: Ryan, Mason & Lewis, LLP, Suite 205, 1300 Post Road, Fairfield, CT, 06824, US

(21) Appl. No.: 10/880,344

(22) Filed: Jun. 29, 2004

(51) Int. Cl. H04L 12/28; H04L 12/56

(52) U.S. Cl. 370/395.1

(57) ABSTRACT

A method and apparatus are disclosed for ATM Adaptation Layer (AAL) staggered constant bit rate cell scheduling. Cells from a plurality of virtual circuits are scheduled. Each of the virtual circuits have a transmission characteristic and each of the plurality of virtual circuits are classified into one of a plurality of stagger groups based on similar transmission characteristics. For each frame synchronization, a cell is transmitted from a given virtual circuit until a predefined cell threshold is exceeded for the stagger group containing the given virtual circuit. A Cell Delay Variation of each of the virtual circuits will not exceed a given time interval. A scheduler can be allocated for each connection or for each period.

### FIELD OF THE INVENTION

The present invention relates generally to cell scheduling techniques and, more particularly, to cell scheduling techniques in an ATM adaptation layer.

### BACKGROUND OF THE INVENTION

Voice networks, such as the Public Switched Telephone Network (PSTN), use time division multiplexed (TDM)-based data links to transport voice information. In contrast, asynchronous transfer mode (ATM) networks use ATM cells, transported according to the ATM protocols, to transport a combination of voice and data. In order to transmit application traffic, an ATM adaptation layer (AAL) is required. An AAL is a standard protocol layer that allows data from multiple applications (e.g., voice, data and video, referred to as “higher layer services”) to be converted between the service data format and the size and format of an ATM cell payload (generally, 48 bytes). The conversion from the service data format to cells is referred to as segmentation, and the conversion from cells back to the service data format is referred to as reassembly. Segmentation and Reassembly (SAR) methods are employed to break up arbitrarily sized packets.

There are several AALs defined for adapting various types of traffic to an ATM network. For example, to emulate TDM-based voice circuits, AAL type 1 (AAL1) has been defined in the ITU-T I1.363.1, B-ISDN ATM Adaptation Layer Specification Type 1 (AAL1) and AF-VTOA-0078, ATM Forum Circuit Emulation Service Interoperability Specification, Version 2.0 standards. AAL1 allows the transport of delay-sensitive voice circuits over an ATM network using a constant bit rate (CBR) class of service. Any impairments in network performance can decrease the quality of the voice transmissions. For example, a cell delay variation (CDV) is the variation in arrival time of a cell from its ideal arrival time. Latencies are due to cell buffering in the network.

A need therefore exists for a cell scheduler for an AAL1 Segmentation and Reassembly method that breaks up arbitrarily sized packets with improved CDV and latency parameters. A further need therefore exists for an AAL1 Segmentation and Reassembly method and apparatus that reduce the cell “clumping” that can lead to unacceptable cell delay variation and delay.

### SUMMARY OF THE INVENTION

Generally, a method and apparatus are disclosed for ATM Adaptation Layer (AAL) staggered constant bit rate cell scheduling. Cells from a plurality of virtual circuits are scheduled. Each of the virtual circuits have a transmission characteristic, such as a cell transmission period, and each of the plurality of virtual circuits are classified into one of a plurality of stagger groups based on similar transmission characteristics. For each frame synchronization, a cell is transmitted from a given virtual circuit until a predefined cell threshold is exceeded for the stagger group containing the given virtual circuit. In this manner, cells in the stagger group containing the given virtual circuit are staggered. Furthermore, a Cell Delay Variation of each of the virtual circuits will not exceed a given time interval, such as one frame synchronization time interval. In one variation, a scheduler is allocated for each connection, while in another variation, a scheduler is allocated for each period. The virtual circuits in a given stagger group may be identified, for example, by accessing a period reference table.

A more complete understanding of the present invention, as well as further features and advantages of the present invention, will be obtained by reference to the following detailed description and drawings.

### BRIEF DESCRIPTION OF THE DRAWINGS

FIG. 1 illustrates the network environment in which the present invention can operate;

FIG. 2 illustrates a three channel TDM data stream, containing TDM data packets TS0, TS1 and TS2 for every 125 microseconds;

FIG. 3 is a table indicating a set of exemplary emission rate equations for various services;

FIG. 4 is a flow chart describing an exemplary implementation of a CBR scheduler incorporating features of the present invention;

FIG. 5 illustrates the periodicity of the credit accumulation by the CBR scheduler of FIG. 4;

FIG. 6 is a flow chart of an exemplary connection configuration process;

FIG. 7 graphically illustrates the evolution of a cell from construction, to scheduling, to emission;

FIG. 8 is an exemplary table for a scheduler parameter table (SPT);

FIG. 9 is a sample table for an exemplary period reference table;

FIG. 10 is a sample table for an exemplary PRT pointer table for an exemplary per connection scheduler implementation;

FIG. 11 is a flow chart describing an exemplary implementation of the schedule flow task for the per connection scheduler;

FIG. 12 is a flow chart describing an exemplary implementation of the emit flow task for the per connection scheduler;

FIG. 13 illustrates exemplary pseudo-code for the per connection scheduler of FIGS. 11 and 12;

FIG. 14 is an exemplary table for a scheduler parameter table (SPT) for a per period scheduler;

FIG. 15 is a sample table for an exemplary staggering table (ST) for the per period scheduler;

FIG. 16 is a sample table for an exemplary common cell available bit vector;

FIG. 17 is a flow chart describing an exemplary implementation of the schedule flow task for the per period scheduler;

FIG. 18 is a flow chart describing an exemplary implementation of the emit flow task for the per period scheduler; and

FIG. 19 illustrates exemplary pseudo-code for the per period scheduler.

### DETAILED DESCRIPTION

The present invention provides a cell scheduler for an AAL1 Segmentation and Reassembly method. The Segmentation and Reassembly method serves as an interworking function (IWF) between TDM-based voice traffic and an ATM network. Two exemplary architectures are described for a frame synchronous CBR scheduler with deterministic staggering. Deterministic staggering prevents any undesired internal buffer management and unacceptable cell delay variation (CDV). Both exemplary architectures provide a CDV of 125 microseconds or less and are efficient enough to be implemented on an integrated circuit at reasonable low cost. One approach requires more computational processing and less memory, while the other approach requires less processing and more memory.

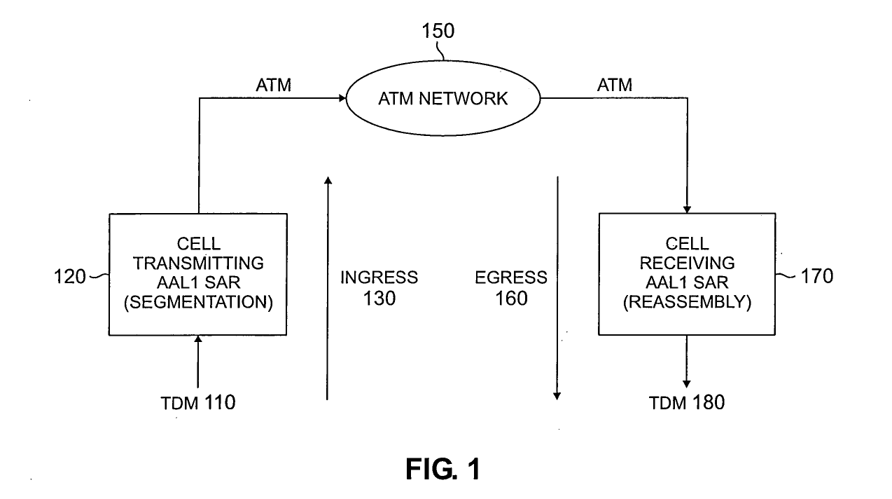

FIG. 1 illustrates the network environment in which the present invention can operate. As shown in FIG. 1, TDM data 110 is processed by a segmentation function of a Segmentation and Reassembly method 120 on an ingress path 130 to an ATM network 150. Generally, the segmentation function of the Segmentation and Reassembly method 120 converts the TDM data to ATM cells. On the egress path 160, a reassembly function of a Segmentation and Reassembly method 170 converts the ATM to TDM data 180.

Generally, on the ingress path 130, the TDM data is received from a voice link. The Segmentation and Reassembly method 120 segments the TDM frames (TDM data buffered for cell construction) and the segmented TDM Frames are put into a payload of ATM cells. The cell is then scheduled to be transmitted, as discussed further below.

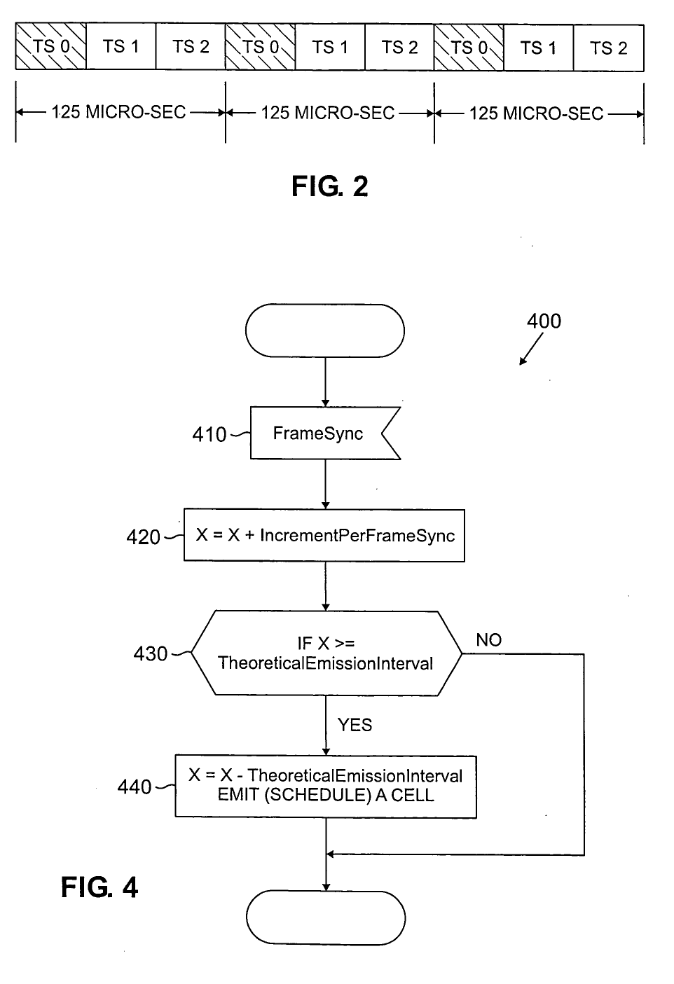

Traditional voice networks, such as the PSTN, typically transmit a single virtual circuit using 8 bits per sample with a sample rate of 8 kHz (8000 samples per second or one sample every 125 μs). Thus, the data rate of a single virtual circuit is typically 64 kbps. A trunk, such as a T1 line, can carry 24 such virtual circuits (i.e., 24 DS0s). Each DS0 is multiplexed into a single data stream having a payload rate of 1.536 Mbps (24×64 kbps) in order to form the data portion of a T1 link (there is also an extra framing bit added to the data to construct the complete T1 data stream). Such a multiplexed data stream is commonly referred to as a “TDM” data stream. For example, FIG. 2 illustrates a three channel TDM stream, containing three TDM packets TS0, TS1 and TS2 for every 125 microseconds. The ATM cells created by the segmentation function of the Segmentation and Reassembly method 120 on the ingress path 130 are typically 53 bytes long (comprised of a 5-byte header and 48 byte payload). The cell payload contains the user traffic.

### AAL1 Transport

As previously indicated, several AALs are defined for adapting various types of traffic to an ATM network. For example, AAL type 1 (AAL1) emulates TDM-based voice circuits and allows the transport of delay-sensitive voice circuits over an ATM network using a constant bit rate (CBR) class of service. There are two types of AAL1 transport:

Untructured Data Transfer (UDT)—Transfers an entire T1 or E1 frame, including framing bits, without regard to the structure of the data stream (e.g., timeslot boundaries, frame boundaries and multi-frame boundaries are not known to the ATM layer).

Structured Data Transfer (SDT)—Transfers N×DS0 timeslots of a T1 or E1 frame. The AAL1 SAR layer is “aware” of the timeslot and frame boundaries, and the timeslot structure information is carried by the ATM cells along with data. SDT mode can be used either with or without signaling support (i.e. transmission of CAS bits at the end of each payload block).

### Cell Schedulers

The present invention provides a cell scheduler for an AAL1 Segmentation and Reassembly method. Two exemplary CBR cell scheduler implementations are described herein that minimize latency and CDV to optimize the performance of the AAL1 SAR. The second implementation allows memory size to be traded for computational complexity, relative to the first implementation.

Cell Scheduler Emission Rates

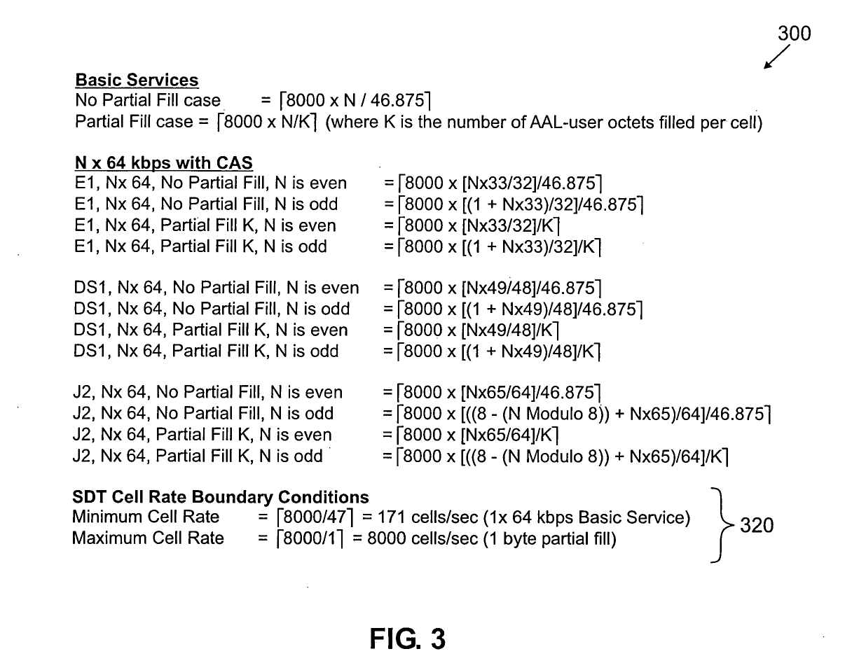

The cell scheduler disclosed herein must support a number of cell emission rates. As previously indicated, the exemplary embodiment is illustrated using AAL type 1 (AAL1) to emulate TDM-based voice circuits in accordance with an exemplary AF-VTOA-0078, ATM Forum Circuit Emulation Service Interoperability Specification, Version 2.0 standard. FIG. 3 is a table indicating a set of exemplary emission rate equations 300 for various services (basic or Channel Associated Signaling (CAS) services). The exemplary emission rate equations 300 shown in FIG. 3 are specified in the ATM Forum AF-VTOA-0078 standard and are derived from the transport requirements of the various AAL1 services. In FIG. 3, the notation ┌x┐ indicates “the smallest integer greater than or equal to x.” In addition, the emission rate equation table 300 identifies a set of boundary conditions 320.

Generally, the emission rates depend on the number, N, of DS0s per AAL1 SDT group (each ATM cell has 1-32 virtual circuits for E1, 1-24 for T1); a denominator, K, and a service type (basic or Channel Associated Signaling (CAS)). Channel Associated Signaling is a form of circuit state signaling in which the circuit state is indicated by one or more bits of signaling status sent repetitively and associated with that specific circuit. The denominator, K, is used in the cell rate calculation, and is equal to (i) the number of partial fill cells, if partial fill is being used; (ii) 46.875, if no partial fill is being used (this is the average number of octets per cell, accounting for one byte of AAL1 SAR overhead per cell and one byte of SDT pointer overhead every 8 cells) or (iii) 47, for the special case of no partial fill and N equal to 1 (because when N=1 no pointer SDT byte is required).

It is noted that partial fill (PF) is an option for SDT AAL1 whereby a cell payload is only partially filled before the cell is transmitted. This option decreases the cell assembly latency at the expense of additional cell overhead. In theory, PF can be as low as one, although in practice PF is typically no less than approximately 20.

Cell Delay Variation (CDV) Requirements

There are no standards specifying CDV for the Segmentation and Reassembly process. Instead, the CDV requirements are described at the system level (not the chip level). Specifically, Telcordia Generic Requirements document GR-1110-CORE describes exemplary CDV requirements for a broadband switching system (BSS), which would include not only an AAL1 SAR but also other ATM devices such as a traffic manager and scheduler. The requirements for such a system are 250 microseconds or less of CDV for DS1-based Circuit Emulation Service (CES). The ATM Forum circuit emulation service interoperability specification specifies interoperability agreements for supporting Constant Bit Rate (CBR) traffic over ATM networks that comply with the other ATM Forum interoperability agreements. Specifically, this specification supports emulation of existing TDM circuits over ATM networks. The requirements for DS0-based CES are not stated. They would typically be less stringent than for DS1, but since the 250 microsecond requirement is for the entire equipment apparatus, then is it reasonable to use the 250 microseconds as a guideline for the upper bound on the acceptable CDV of an AAL1 SAR for the present application. In an exemplary embodiment of the present invention provides a CDV requirement of 125 microseconds. Thus, the disclosed CBR scheduler can guarantee a CDV that corresponds to one frame sync time interval.

The contribution of the SAR to end-to-end latency of the system is minimized when CDV is kept to a minimum because the buffers for playing out the cell payload to the TDM line do not need to be as deep (i.e. they don't need to be able to absorb a large CDV).

Staggered Scheduling

The CBR scheduler provided by the present invention is referred to as a “staggered” scheduler because the times at which completed cells are scheduled to be transmitted are staggered in time relative to one another. The staggering is done on a frame basis (125 microseconds), so the staggering can also be referred to as “Frame-Based Scheduling.” This staggering provides a smoothing effect, reducing cell “clumping.” Cell clumping can cause increased CDV and cell transmission latency.

For an illustrative system having 84 T1 links, each having 24 independent channels of AAL1 (i.e. single DS0 channels), there are a total of 2016 AAL1 channels. In the worst case, all 2016 cells being assembled can be ready to transmit in the same 125 microsecond period. Cells can be scheduled to a 16-bit, 50 MHz UTOPIA-2 (UL-2) interface, which can transmit a maximum of approximately 183 cells in a single 125 microsecond period. Thus, it will take 15×125 microsecond periods (2016/183) to transmit all the cells, or approximately 2 millisecond (accounting for UTOPIA interface overhead and other factors). This 2 millisecond represents the added latency and CDV to the last cell transmitted.

Clearly, this cell clumping must be avoided in order to meet a desired 125 microsecond CDV requirement. Furthermore, note this example does not represent a “worst-case” scenario which has low probability of occurrence, because the TDM interfaces on the exemplary for Link Layer Processor (LLP) that incorporates the per period scheduler of the present invention are typically operated synchronously (meaning that the frame syncs of every TDM link will align). The staggering provides a way to control when cells are assembled such that it can guarantee that all cells that are backlogged can be scheduled in a 125 microsecond period (frame).

UDT Considerations

Note that scheduling only UDT traffic for the exemplary 84 T1 links would be straightforward (no staggering algorithm would be required), because the maximum number of cells requiring transmission in any single 125 microsecond time period is 84, which is significantly less than 183. The cell clumping described above mainly arises due to the large amount of cells that can be backlogged because of potentially small channel sizes in an SDT application. For applications with a mix of SDT/UDT traffic, the staggering algorithm can be used for both SDT and UDT traffic by dedicating an entire period in the stagger tables to each active UDT VC.

Algorithm

FIG. 4 is a flow chart describing an exemplary implementation of a CBR scheduler 400 incorporating features of the present invention. As shown in FIG. 4, the CBR scheduler 400 initially establishes frame synchronization during step 410. Thereafter, at every frame sync, a credit variable, X, is incremented by “IncrementPerFrameSync” during step 420. Thus, X is the current credit to emit (schedule) a cell.

Once it is determined during step 430 that X is greater than or equal to a threshold, TheoreticalEmissionInterval, then the cell is emitted (scheduled) and the credit, X, loses a credit equal to TheoreticalEmissionInterval during step 440.

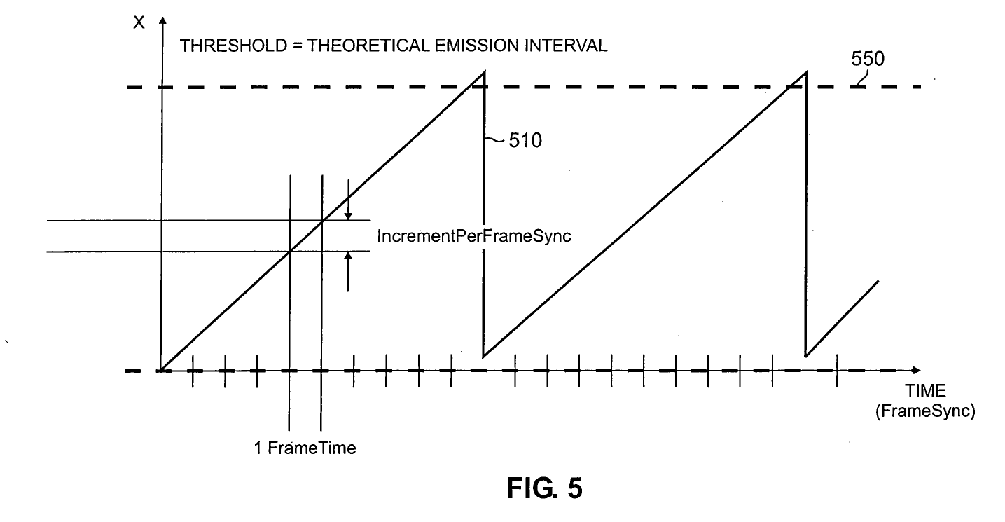

The periodicity of the credit accumulation by the CBR scheduler 400 is shown in FIG. 5. As shown in FIG. 5, the variable, X, is incremented by an amount equal to IncrementPerFrameSync for each frame sync interval (FrameTime), until the threshold 550 is reached. After the threshold 550 is reached, the variable, X, is decremented by the credit value. The FrameSync Scheduler is thus a type of periodic signal generator, where the period is equal to the Thereshold divided by the IncrementperFS value (×125 microseconds). Thus, 183 independent periodic signals are possible per scheduling interval for a UL-2, 50 MHz implementation, and 244 independent periodic signals are possible for an SPI-3, 133 MHz implementation.

The CBR scheduler 400 employs the exemplary emission rate equations 300, discussed above in conjunction with FIG. 3 to determine the value of IncrementPerFrameSync. The IncrementPerFrameSync variable employed by the CBR scheduler 400 has a value of N×48 for DS1 Basic service; N×32 for E1 Basic service; N×49 for DS1 CAS service with N equal to an even value; 1+N×49 for DS1 CAS service with N equal to an odd value; N×33 for E1 CAS service with N equal to an even value; or 1+N×33 for E1 CAS service with N equal to an odd value.

The threshold, TheoreticalEmissionInterval, is K×32 for E1 channels and K×48 for DS1 channels.

For example, for a DS1 basic service, with 1×64k (where 1×64k indicates a single 64 Kbit DS0 channel (8 bits*8000 Hz) and more generally N×64K means N 64 Kbit DS0 channels (1×64K)), and the parameters N equal to 1 DS0, K=47 (for the special case of no partial fill and N equal to 1), the variable IncrementperFS equals N×48 or 48 and the Threshold equals K×48 or 2256 (47×48). For a DS1 CAS service, with 3×64k [PLS. EXPLAIN], and the parameters N=3 and K=46.875, the variable IncrementperFS equals 1+N×49 or 148, and the Threshold equals K×48 or 2250 (46.875×48). For a DS1 CAS service with 4×64k and partial Fill (K=10), the parameters N=3 and K=10, the variable IncrementperFS equals N×49 (196) and the Threshold equals K×48 or 480 (10×48).

The same period can be used but different phase signals (as many as └K/N┘=46 for the exemplary embodiment) to establish the scheduling (emission) time for independent signals having the same rate. Thus, 46 channels can share the opportunity to send a cell without a collision, while waiting to accumulate the X value to the threshold.

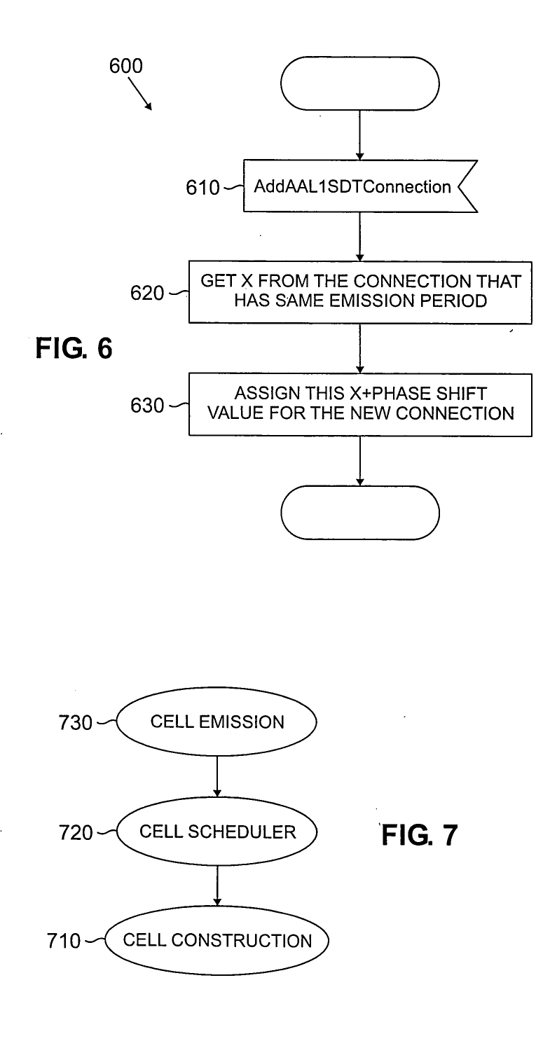

FIG. 6 is a flow chart of an exemplary connection configuration process 600. As shown in FIG. 6, the connection configuration process 600 is initiated during step 610 when a new connection is requested, such as an AAL1 SDT Connection. The value of X is obtained during step 620 from the connection that has the same emission period. (If the connection is the first connection of the new period, then it's the same as the basic configuration). The value of X is changed during step 630 by the desired time difference (phase shift) from the reference.

### Exemplary Scheduler Implementations

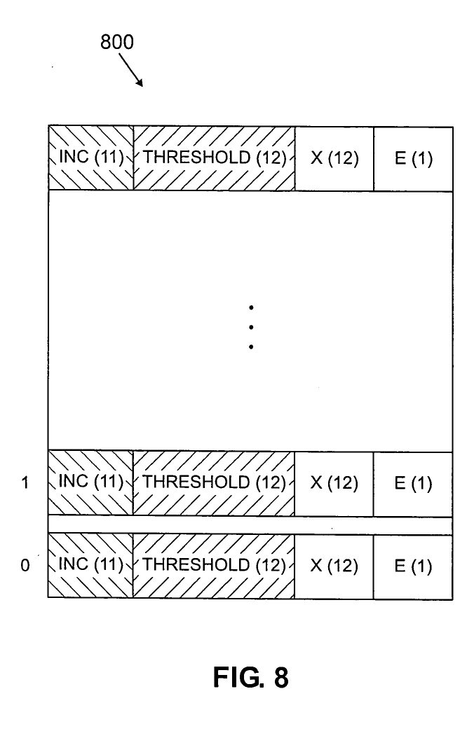

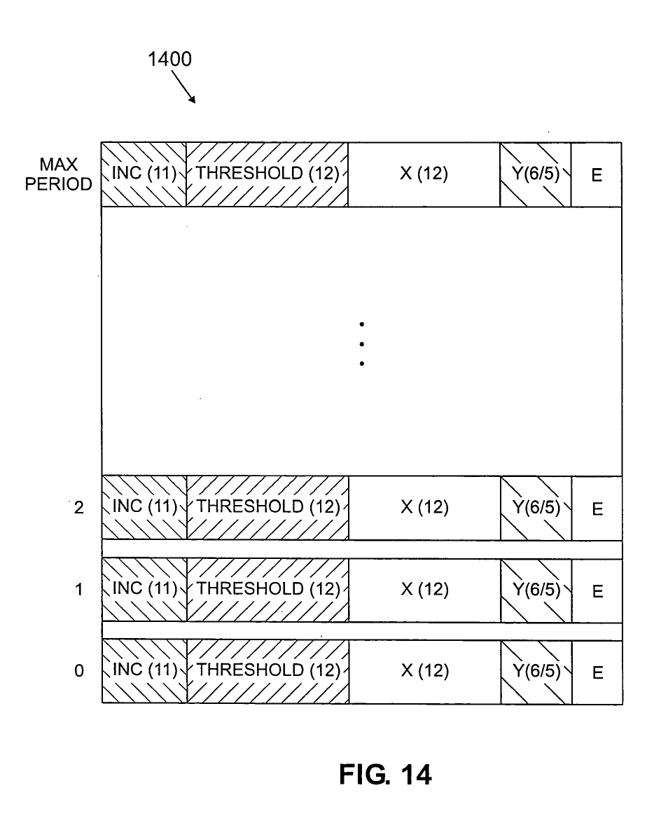

As previously indicated, there are two exemplary architectures described herein for a frame synchronous CBR scheduler with deterministic staggering. A per connection scheduler, discussed below in conjunction with FIGS. 8-13, allocates and operates a scheduler per connection. A per period scheduler, discussed below in conjunction with FIGS. 14-19, allocates and operates a scheduler per period.

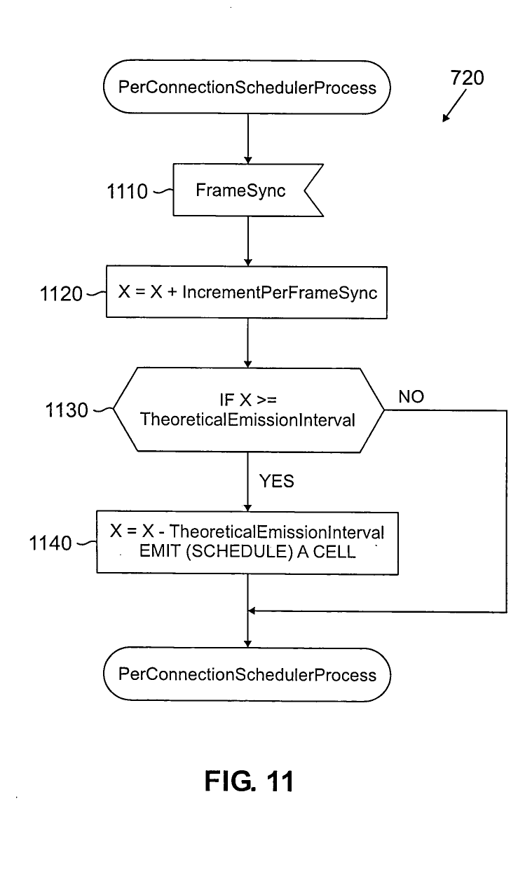

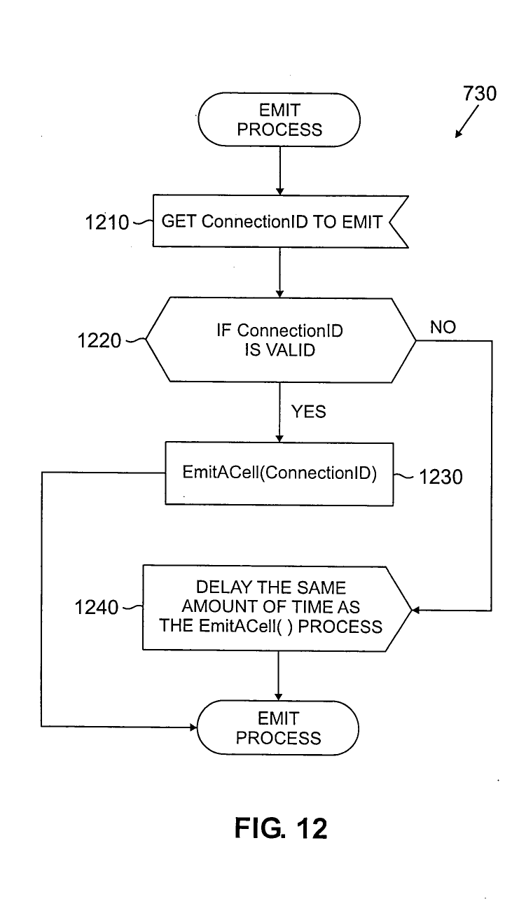

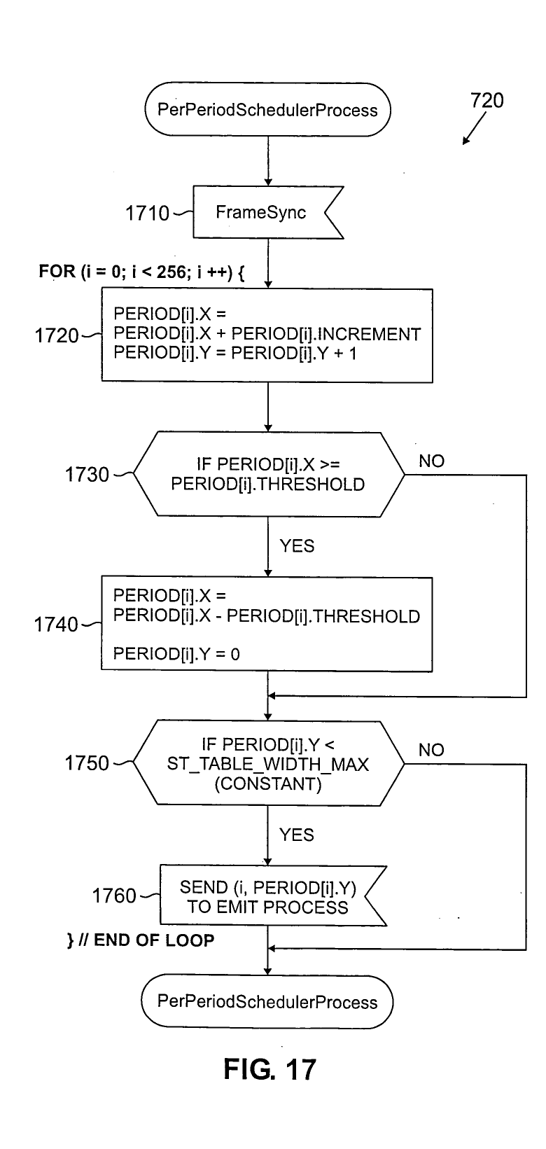

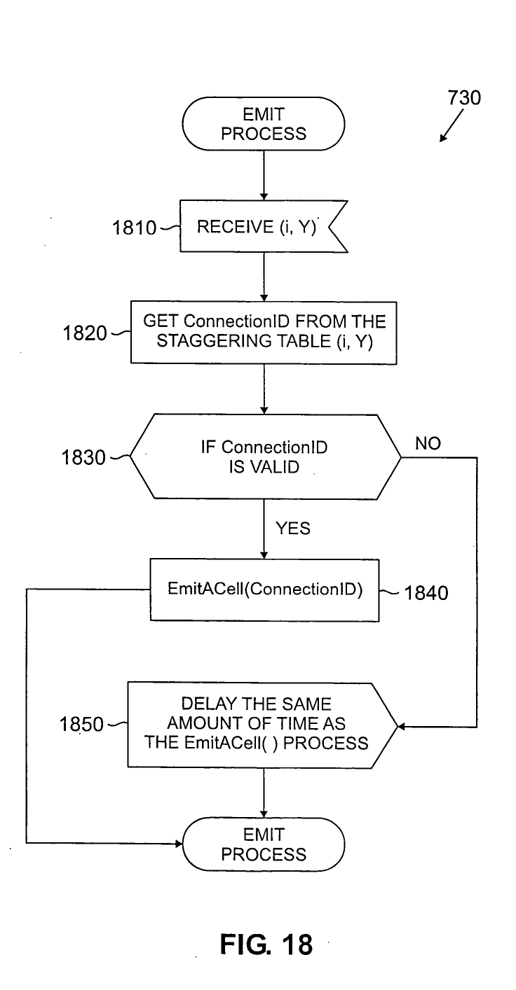

FIG. 7 graphically illustrates the evolution of a cell from construction during step 710, to scheduling during step 720, to emission during step 730. The construction of a cell is outside the scope of the present invention. The scheduling of a cell 720 is discussed further below in conjunction with FIGS. 11 and 17 for the per connection and per period implementations, respectively. The emission of a cell 730 is discussed further below in conjunction with FIGS. 12 and 18 for the per connection and per period implementations, respectively.

### Per Connection Implementation

As indicated above, a per connection scheduler, discussed below in conjunction with FIGS. 8-13, allocates and operates a scheduler per connection. FIG. 8 is an exemplary table for a scheduler parameter table (SPT) 800. As shown in FIG. 8, the scheduler parameter table 800 has a record associated with each connection (up to a maximum number of supported connections). For each connection, the scheduler parameter table 800 identifies the Increment Value (Inc) for the VCID, the threshold (a value that determines service eligibility and is a function of period of the connection), the value X (i.e., the current offset value for the virtual circuit (VC) that is incremented as time increases) and a flag, E, that indicates whether the VC is enabled. The values stored in the scheduler parameter table 800 must be updated for each frame.

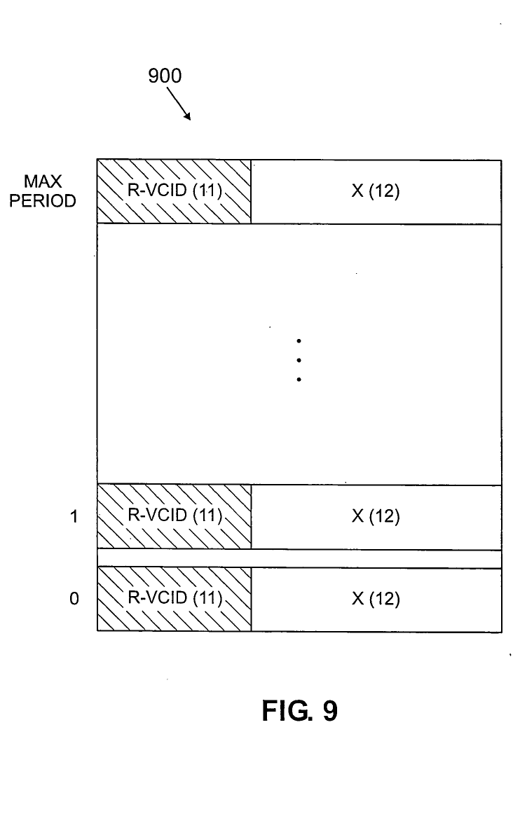

FIG. 9 is a sample table for an exemplary period reference table 900. As shown in FIG. 9, the period reference table 900 has a record associated with each period (up to a maximum number of supported periods). For each period, the period reference table 900 identifies the Reference VC Identifier (R-VCID). The R-VCID value changes each time a new connection is added to that VC stagger group (VSG), as discussed below, and each time the connection in that VSG that is being used as the reference is torn down. The R-VCID value is used to determine the “staggered” location for the next connection of the same rate. The R-VCID value can also be changed “on the fly” by the host in order to target an open spot in the VSG row when the row is densely populated (this is how the host manages the stagger table population). In addition, the period reference table 900 indicates the offset value for the VC Group whose reference is R-VCID. Initially, the offset value is zero, but is updated every frame cycle by <increment> by copying corresponding SPT's X value that is pointed by R-VCID.

The period reference table 900 contains one entry per VC stagger group (VSG). A VSG is comprised of a number of VCs, all of the same rate, that are members of the same “row” of a “stagger table” that is a virtual table maintained by the host software, as discussed below in a section entitled “Cell Staggering.” Each column of a row represents an offset of one stagger position (frame sync). The maximum number of VCs in a VSG depends on the rate of the connections in the group, e.g., 46 for 64 kB connections and proportionally less for higher rates. Higher-rate connections will occupy fewer columns in the stagger table, because their periods are shorter.

There is no fixed relationship between columns of different rows in the “stagger table.” The columns “float” with respect to each other's relative position. The main point is that the sum of all populated rows must be less than 183 (the maximum amount of cells that can be scheduled in a single frame sync (FS) period).

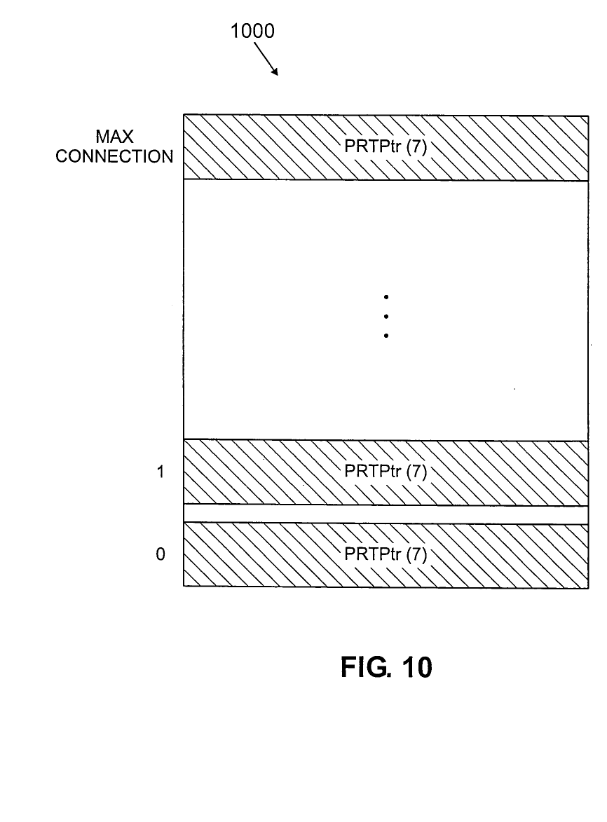

FIG. 10 is a sample table for an exemplary PRT pointer table 1000 for the per connection scheduler. As shown in FIG. 10, the PRT pointer table 1000 has a record associated with each connection (up to a maximum number of supported connections). For each connection, the PRT pointer table 1000 identifies a pointer, PRTPtr, to the PRT Table entry that corresponds to the rate for this connection. The pointer is used at the end of each VCID's processing to determine if the corresponding VCID is a reference VCID (if so, the reference VCID's offset in the PRT is updated).

FIG. 11 is a flow chart describing an exemplary implementation of the schedule flow task 720 for the per connection scheduler. As shown in FIG. 11, the schedule flow task 720, also referred to as the per connection scheduler process, is similar to the CBR scheduler 400, discussed above in conjunction with FIG. 4. The schedule flow task 720 initially establishes frame synchronization during step 1110. Thereafter, at every frame sync, a credit variable, X, is incremented by “IncrementPerFrameSync” during step 1120. Thus, X is the current credit to emit (schedule) a cell.

Once it is determined during step 1130 that X is greater than or equal to a threshold, TheoreticalEmissionInterval, then the cell is emitted (scheduled) and the credit, X, loses a credit equal to TheoreticalEmissionInterval (i.e., X is reset) during step 1140.

FIG. 12 is a flow chart describing an exemplary implementation of the emit flow task 730 for the per connection scheduler. As shown in FIG. 12, the emit flow task 730 initially obtains a connection identifier during step 1210 to emit. A test is performed during step 1220 to determine if the obtained connection identifier is valid. If it is determined during step 1220 that the obtained connection identifier is not valid, then program flow proceeds to step 1240 where a delay is introduced equal to the processing time of an EmitACell process.

If it is determined during step 1220 that the obtained connection identifier is valid, then program flow proceeds to step 1230 where an EmitACell process is initiated for the obtained connection identifier. Program control then terminates.

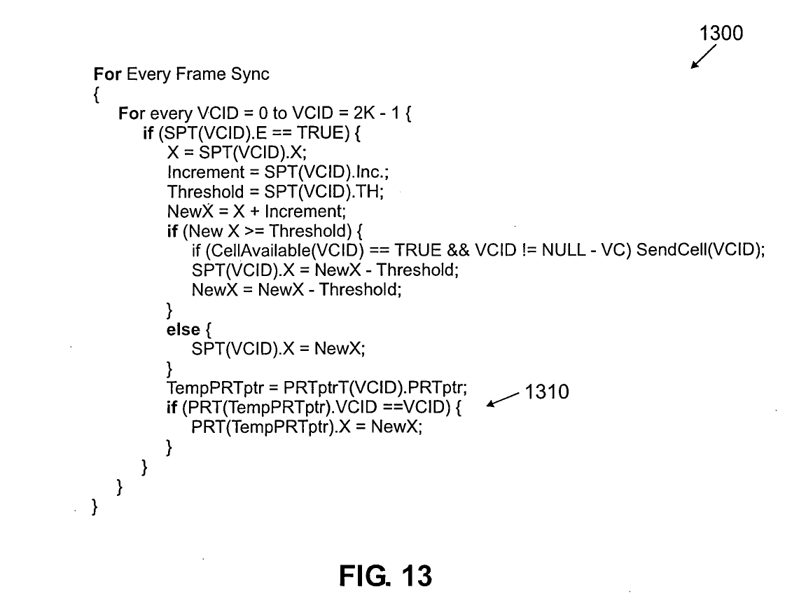

FIG. 13 illustrates exemplary pseudo-code for the per connection scheduler. At line 1310, if this is the “reference” VCID, then the PRT is updated with the current offset value so that the next new connection will be staggered relative to this dynamically moving value.

To setup a connection in the per connection scheduler implementation, the scheduler tables are initialized and the scheduler is enabled. The cell construction 710 is also enabled. It is recommended that it is delayed at least 1 frame sync from the scheduler initialization.

To tear down a connection in the per connection scheduler implementation, the cell construction 710 is disabled. Once the cell FIFO is empty (either by waiting or using a cell FIFO flush method), the scheduler is disabled and the related tables are cleared. Thus, each frame sync time can be divided into a connection setup/tear down phase, if required, and a scheduling phase.

A. Connection Set-Up Procedure

If the host determines that the rate (period) for the connection is a new rate, then a free entry is updated in the period reference table 900 with the new VCID; the corresponding PRT Table Index (PRTptr) is obtained and stored in PRTptrT(VCID).PRTPtr in the PRT pointer table 1000. The value of SPT(VCID).E is updated (=1) and the parameters INC, Threshold and X are set.

If the host determines that the VCID's rate is already present, then the Reference VCID for that period (rate group) is obtained from the period reference table 900 and used to fetch its corresponding PRTptr from the PRTptrT, PRT pointer table 1000, as follows:

newPRTptr=PRTptrT(R-VCID).PRTptr.

From above, the new connection's offset pointer is set in PRTptrT, as follows:

PRTptrT(VCID_{N}).PRTptr=newPRTptr.

The current VCID is made the Reference VCID for its rate Group (so the new connection for this rate group will be staggered relative to this one), as follows:

PRT(newPRTprt).R-VCID=VCIDN.

A. Connection Teardown Procedure

If the host determines that the connection to be torn down (VCIDₜ) is one of the reference VCIDs in the PRT, then the host chooses a new reference, R-VCID_{N} from the same rate group (based on where host wants next connection to be staggered). A new reference VCID's offset pointer is obtained from PRTptrT (PRT pointer table 1000), as follows:

newPRTptr=PRTptrT(VCID_{N}).PRTptr.

The reference VCID is updated to the new value:

PRT(newPRTptr).R-VCID=VCID_{N}.

The “E” bit is cleared of the torn down connection:

SPT(VCIDt).E=FALSE.

Otherwise, if the host determines that the VCID is not one of the R-VCIDs in the PRT, then:

SPT(VCID).E=FALSE.

Reference VCID Reassignment

In the same way that the host assigns a new reference VCID when it tears down a connection that is currently the reference VCID, it can also autonomously change the reference VCID “on the fly” using the same process, as discussed above. This is necessary when a row in the PRT 900 gets “fragmented” and the customer wishes to set a new R-VCID so that the next new connection for that row will occur in a spot that is “open.”

### Per Period Implementation

As indicated above, a per period scheduler, discussed below in conjunction with FIGS. 14-19, allocates and operates a scheduler per period.

FIG. 14 is an exemplary table for a scheduler parameter table (SPT) 1400 for a per period scheduler. As shown in FIG. 14, the scheduler parameter table 1400 has a record associated with each period (up to a maximum number of supported periods). For each period, the scheduler parameter table 1400 identifies the Increment Value (Inc) for the period, the threshold (a value that determines service eligibility and is a function of period of the connection), the value X (i.e., the current offset value for the virtual circuit period) that is incremented as time increases), a value Y that is the relative distance from the offset value and is used in determining which VC to serve within the VCs belonging to the same period, and a flag, E, that indicates whether the period is enabled.

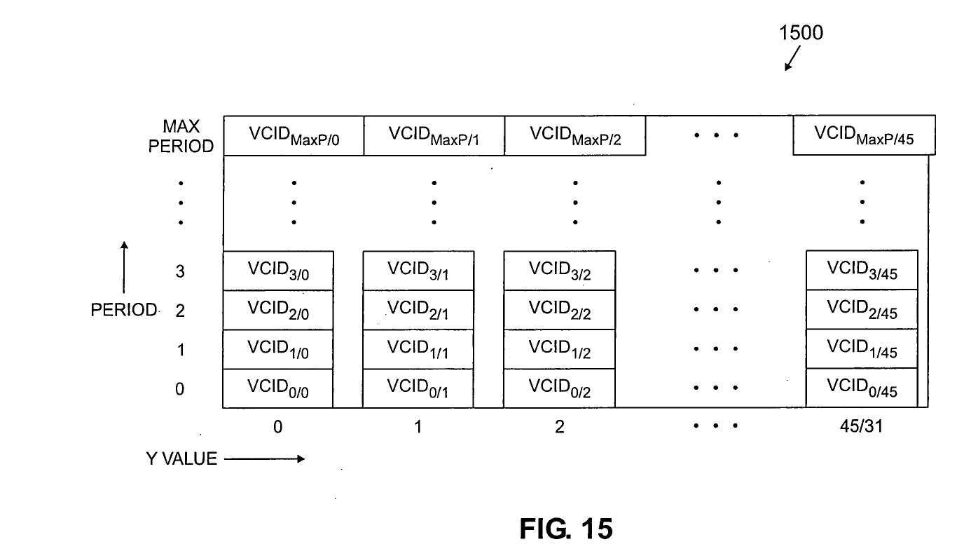

The scheduler parameter table (SPT) 1400 for a per period scheduler contains one entry per VC stagger group (VSG). A VSG is comprised of a number of VCs, all of the same rate, that are members of the same “row” of the stagger table (see FIG. 15). Each column of a row represents an offset of one stagger position (frame sync). The maximum number of VCs (columns) in a VSG depends on the rate of the connections in the group, e.g., up to 47 for 64 kB connections and proportionally less for higher rates (note that the stagger table (FIG. 15) can use 5 bits and limit itself to 32 entries or can use 6 bits and have the maximum size of 47, at the convenience of the implementer).

Higher-rate connections will occupy fewer columns in the stagger table 1500, because their periods are shorter. As a result, the maximum value of Y is proportionally less for higher rates than for lower rates (Y is reset to 0 whenever the threshold for that period is exceeded, so Yₘₐₓ−1 represents the number of frame syncs per period for that rate).

Although the columns are illustrated as being aligned, alignment generally exists only for rows of the same rate (because when a row is provisioned that has the same rate as an existing row, the new row copies the SPT values from the old row). For rows of different rates, there is no fixed relationship between the Y=0 column for Period N and the Y=0 column for Period M if those periods are for different rates. They “float” with respect to each other. The main point is that the sum of all populated rows must be less than 183 (the maximum amount of cells that can be scheduled in a single frame sync period). To prevent resource starvation due to highly fragmented VSGs, it is recommended to have a number of rows in the SPT 1400 that exceeds the minimum number of required periods.

FIG. 15 is a sample table for an exemplary staggering table (ST) 1500 for the per period Scheduler. As shown in FIG. 15, the staggering table 1500 includes a number of records, each associated with a different period (up to a maximum number of supported periods). For each period, the staggering table 1500 contains an entry for each virtual circuit to be serviced. In other words, the staggering table 1500 includes an entry for each virtual circuit per period. Each entry contains a VC identifier or channel number for a virtual circuit to be serviced.

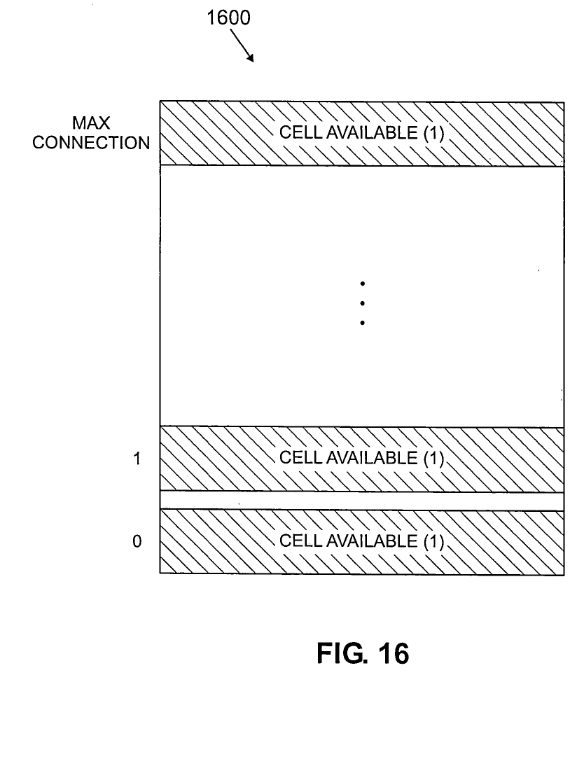

FIG. 16 is a sample table for an exemplary common cell available bit vector 1600. As shown in FIG. 16, the common cell available bit vector 1600 includes an entry for each connection, up to the maximum number of connections, that indicates whether or not a cell is available to schedule.

FIG. 17 is a flow chart describing an exemplary implementation of the schedule flow task 720 for the per period scheduler. As shown in FIG. 17, the schedule flow task 720, also referred to as the per period scheduler process is performed for each period and initially establishes frame synchronization during step 1710. Thereafter, a period credit variable, period{i}.X, is incremented by period{i}.Increment during step 1720. In addition, the relative distance value, Period{i}.Y is also incremented by period{i}.Y+1 during step 1720.

Once it is determined during step 1730 that period{i}.X is greater than or equal to a period{i}. threshold, then the credit, period{i}.X, loses a credit equal to period{i}. threshold (i.e., period{i}.X is reset) during step 1740.

Once it is determined during step 1750 that period{i}.Y is less than a maximum width for the staggering table (ST) 1500 (a constant), then the cell is scheduled (sent to the emit process).

To guarantee quality of service, it is required that the number of active periods be less than the maximum number of cells that can be transmitted by the UL-2 or SPI-3 interface in one frame period.

FIG. 18 is a flow chart describing an exemplary implementation of the emit flow task 730 for the per period scheduler. As shown in FIG. 18, the emit flow task 730 is initiated during step 1810 with the values i and Y. A connection identifier is obtained during step 1820 from the staggering table 1500. A test is performed during step 1830 to ensure that the connection identifier is valid. If the connection identifier is valid, then the cell is emitted during step 1840. If the connection identifier is not valid, then program flow proceeds to step 1850 where a delay is introduced equal to the processing time of an EmitACell process.

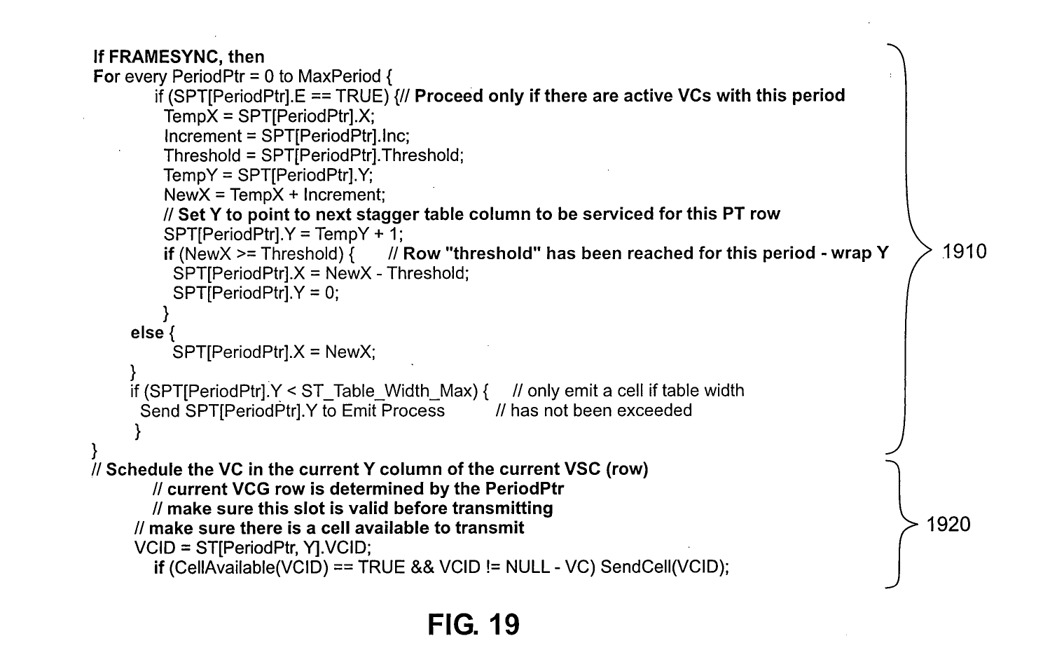

FIG. 19 illustrates exemplary pseudo-code for the per period scheduler. As shown in FIG. 19, the exemplary pseudo-code includes a first section 910 for the schedule process 720 and a second section 920 for the emit process 730.

To setup a connection in the per period scheduler implementation, the scheduler tables are initialized and the scheduler is enabled. The cell construction 710 is also enabled.

To tear down a connection in the per connection scheduler implementation, the cell construction 710 is disabled. The flushing of the cell FIFOs is to be handled at the discretion of the implementor. Thus, each frame sync time can be divided into a connection setup/tear down phase, if required, and a scheduling phase.

A. Connection Set-up Procedure

If the host determines that the rate (period) for the connection is a new rate, then the following steps are performed:
1. Obtain a Free PeriodPtr;
2. Set ST[PeriodPtr, Y=0].VCID=VCID; and
3. Set SPT[PeriodPtr].E=1 and initialize Inc, Threshold, X=0, Y=0.
   Otherwise, if the host determines that the VCID's rate is already present, then the following steps are performed:
1. Get the PeriodPtr for that rate and write the VCID in a free entry, typically the one corresponding to ST[PeriodPtr, Y=next]; and
2. If there are no free entries in the current period (VCG), then follow the approach above as if it was a new rate. For this case, copy the SPT[PeriodPtr] entries from the full VCG to the SPT entries pointed to by the new PeriodPtr, in order to synchronize the columns of both rows. This allows row consolidation (defrag) later if the rows become sparsely populated.

A. Connection Teardown Procedure

If the host determines that the VCID is not the last one for the period group, then the corresponding entry is set with NULL-VC in the ST[PeriodPtr, Yt].VCID entry.

If the host determines that the VCID is the last active VCID for the period group, then the following assignments are implemented:

Update SPT(PeriodPtr).E=FALSE; and

ST[PeriodPtr, Yt].VCID=Null-VC.

Comparison of Per-Connection & Per-Period Schedulers

In the per-period implementation, the stagger table 1500 is explicitly stored in the scheduler block, allowing the firmware to select only those staggered values (columns) that are ready for service rather than having to update and check every connection for service. This saves a large amount of computation time. In a per-connection implementation, every connection's offset had to be checked at each frame sync because there was no stagger table stored locally. In both cases, the host stores stagger information separately, and it is up to the host to manage the relative staggering between connections in the same period. This is accomplished in a per-connection implementation by managing the reference VCID value, since the “next” connection is always staggered by one relative to the current R-VCID. In a per-period implementation, the host can have an image of the staggering table in its local memory to determine which slots are available.

The per-period scheduler may require management of fragmented connections. For example, it is possible that, after establishing and tearing down many connections, there are two adjacent CG rows that have the same N=1 rate but contain only one populated entry each. If the entries are in different columns, then the two rows can be consolidated into one. However, if the entries are in the same column of their respective rows, then the two rows can not be consolidated without de-fragmentation operations on the stagger table (ST). In the extreme, if de-fragmentation operations could not take place and there were many connections with this property, it could cause SPT table resource starvation. The probability of this is fairly low, and the penalty would simply be a denied connection rather than a system malfunction. However, it may thus be desirable to allocate more SPT period rows than the minimum required.

De-fragmentation of the ST may be accomplished between periods in the SPT which have common periods and parameters. Moving a VC along a column of the ST will always introduce an additional CDV delta of less than 125 microseconds for that VC in the next cell transmission. Moving a VC along a row a single space left or right will always introduce an additional CDV delta of 125 microseconds for that VC in the next cell transmission. By limiting the frequency and type of de-fragmentation operations it is possible to de-fragment the ST tables without introducing more than 125 microseconds of CDV.

The per-connection scheduler needs to manage the reassignment of the PRT reference connection whenever that connection is torn down, or when the VCG becomes fragmented and it is necessary to move the reference point.

Both scheduler implementations can cause a maximum two cell construction time delay in the worst case.

### Cell Staggering

The per connection and per period implementations described above both stagger the cell emission in a controlled manner, in order to guarantee that no more than 183 cells are backlogged during any 125 microsecond period in the exemplary embodiment (ensuring that they will all be transmitted in a 125 microsecond period). For cell staggering, both implementations conceptually employ a two-dimensional stagger table (either a virtual table residing in the host software or a physical table 1500 residing in the SAR). Each row of the table is called a VC stagger group (VSG). A VSG is comprised of a number of VCs (ATM connections) of the same rate. Each successive entry (column) of a row represents an offset of one stagger position (125 microsecond frame sync period). The maximum number of VCs (columns) in a VSG depends on the rate of the connections in the group, e.g., 46 for 64 kB connections (N=1) and proportionally less for higher rates, for example, a single column for N=24 (a full T1). Higher-rate connections occupy fewer columns because their periods are lower.

The staggering algorithm steps successively through the column entries of a row, serving one column every frame sync period (125 microseconds). If the column contains an active VC, a cell from that VC's queue is scheduled for transmission (inactive entries are populated with a NULL-VC indicator). Each VCG (row) in the table is serviced every frame time. Since a new stagger position is served every frame time, this component of the scheduler is referred to as the “frame-based scheduler.”

### CBR “Period Scheduler” (Rate-Based Scheduling)

The CBR scheduler should be rate accurate while minimizing the amount of CDV created by the scheduling process, since an inaccurate rate or excessive CDV could cause degradation in voice quality. To achieve an accurate CBR scheduling behavior, a leaky-bucket type scheduler is used that operates on a principle similar to the GCRA UPC described in the ATM standards and well-understood in the industry. The leaky bucket scheduler ensures that a VCG row doesn't “wrap” until the threshold for that VCG is exceeded (“wrapping” refers to the process of re-scheduling a row for service once the frame-based scheduler has serviced its last column). In this implementation, the wrap time for a particular row will always vary by a single frame time; either a wrap will occur the next frame time or after a one frame delay. This is how the rate accuracy is kept to within a frame time (125 microseconds).

This operation is conceptually similar to the way that a digital PLL uses two different counts to achieve an average frequency (rate) that is somewhere between the two values. Since VCGs of different periods (rates) will wrap at different times, there is no fixed relationship between the first columns of VCGs of different rates; they “float” with respect to each other. In contrast, corresponding columns for VCGs of the same rate will always be aligned.

Regardless of whether the VCGs are floating or not, the frame scheduler only needs to guarantee that the worst case number of rows served in any give frame time (assuming any arbitrary column alignment) never exceeds 183, since that is the maximum amount of cells that can be scheduled per period without exceeding the CDV bounds. This sets the upper bound for the number of rows in the stagger table.

### Elimination of CDV Due to Cell Emission Variation

In addition to the CDV of 125 microseconds that is inherent in the design of the exemplary CBR scheduler, there is also another possible source of CDV in the scheduler. This source of CDV arises due to the variation in how many cell emissions are scheduled within a single frame scheduling time. For example, consider a worst case scenario where a cell from VC#n is scheduled at two different instants in time. During the first instant, the cell from VC#n is the only cell to be scheduled. In this case, there is negligible delay from the time the cell is scheduled until the time it is emitted. During the second instant, a cell from every VCG is scheduled. If there are 100 VCGs and VC#n happens to be in the last VCG to be scheduled for that frame, it's emission will be delayed by 99 cell emission times (in the upper limit, an addition frame time).

In order to eliminate this additional CDV, the scheduler is implemented such that the emit process and the non-emit process for each VSG consume the same amount of time. This ensures that a period always emits a cell at the same relative intra-frame time regardless of how many other cells have been scheduled in that frame.

It is to be understood that the embodiments and variations shown and described herein are merely illustrative of the principles of this invention and that various modifications may be implemented by those skilled in the art without departing from the scope and spirit of the invention.

1. A method for scheduling cells from a plurality of virtual circuits, each of said virtual circuits having a transmission characteristic, each of said plurality of virtual circuits classified into one of a plurality of stagger groups based on similar transmission characteristics of said virtual circuits, said method comprising the steps of:
establishing frame synchronization; and
for each frame synchronization, transmitting a cell from a given virtual circuit until a predefined cell threshold is exceeded for said stagger group containing said given virtual circuit.

2. The method of claim 1, wherein said step of transmitting a cell from a given virtual circuit for each frame synchronization staggers cells in said stagger group containing said given virtual circuit.

3. The method of claim 1, wherein said similar transmission characteristics comprises similar cell transmission periods.

4. The method of claim 1, wherein said step of transmitting a cell further comprises the step of identifying said given virtual circuit by accessing a period reference table.

5. The method of claim 1, wherein a scheduler is allocated for each connection.

6. The method of claim 1, wherein a scheduler is allocated for each period.

7. The method of claim 1, wherein said method ensures that a Cell Delay Variation of each of said virtual circuits does not exceed a given time interval.

8. The method of claim 9, wherein said given time interval is one frame synchronization time interval.

9. The method of claim 1, further comprising the step of segmenting TDM data received from one or more voice links.

10. The method of claim 1, wherein said transmitting step employs a leaky bucket type scheduling.

11. The method of claim 10, wherein said leaky bucket type scheduling ensures that each of said plurality of stagger groups do not wrap until the corresponding predefined cell threshold is exceeded for the stagger group.

12. The method of claim 1, wherein said transmitting step employs a staggering table comprised of a plurality of rows corresponding to one of said stagger groups, wherein each of said stagger groups is comprised of a number of virtual circuits of the same rate, wherein each successive entry of a row represents an offset of one stagger position and wherein said transmitting step further comprises the steps of processing one entry for every frame synchronization period and scheduling an active virtual circuit contained in the entry for transmission.

13. A communication node, comprising:
one or more ports for receiving cells from a plurality of virtual circuits, wherein each of said virtual circuits having a transmission characteristic, each of said plurality of virtual circuits classified into one of a plurality of stagger groups based on similar transmission characteristics of said virtual circuits; and
a transmitter for transmitting a cell for each frame synchronization from a given virtual circuit until a predefined cell threshold is exceeded for said stagger group containing said given virtual circuit.

14. The communication node of claim 13, wherein said transmitter staggers cells in said stagger group containing said given virtual circuit.

15. The communication node of claim 13, wherein said similar transmission characteristics comprises similar cell transmission periods.

16. The communication node of claim 13, wherein said transmitter identifies said given virtual circuit by accessing a period reference table.

17. The communication node of claim 13, wherein a scheduler is allocated for each connection.

18. The communication node of claim 13, wherein a scheduler is allocated for each period.

19. The communication node of claim 13, wherein said transmitter ensures that a Cell Delay Variation of each of said virtual circuits does not exceed a given time interval.

20. The communication node of claim 19, wherein said given time interval is one frame synchronization time interval.

21. The communication node of claim 13, further comprising means for segmenting TDM data received from one or more voice links.

22. The communication node of claim 13, wherein said transmitter employs a leaky bucket type scheduling.

23. The communication node of claim 22, wherein said leaky bucket type scheduling ensures that each of said plurality of stagger groups do not wrap until the corresponding predefined cell threshold is exceeded for the stagger group.

24. The communication node of claim 13, wherein said transmitter employs a staggering table comprised of a plurality of rows corresponding to one of said stagger groups, wherein each of said stagger groups is comprised of a number of virtual circuits of the same rate, wherein each successive entry of a row represents an offset of one stagger position and wherein said transmitting step further comprises the steps of processing one entry for every frame synchronization period and scheduling an active virtual circuit contained in the entry for transmission.

25. A transmitter, comprising:
one or more ports for receiving cells from a plurality of virtual circuits, wherein each of said virtual circuits having a transmission characteristic, each of said plurality of virtual circuits classified into one of a plurality of stagger groups based on similar transmission characteristics of said virtual circuits;
means for establishing frame synchronization; and
means for transmitting, for each frame synchronization, a cell from a given virtual circuit until a predefined cell threshold is exceeded for said stagger group containing said given virtual circuit.
